(19) United States
(12) Patent Application Publication
(10) Pub. No.: US 2005/0219517 A1
(43) Pub. Date: Oct. 6, 2005

(54) Light environment measuring system suitable for measuring in the forest

(75) Inventors: Takafumi Tanaka, Nagoya City (JP); Takeshi Ohta, Nagoya City (JP)

Correspondence Address: OLIFF & BERRIDGE, PLC, P.O. BOX 19928, ALEXANDRIA, VA, 22320, US

(73) Assignee: NATIONAL UNIVERSITY CORPORATION NAGOYA UNIVERSITY, Nagoya City (JP)

(21) Appl. No.: 11/091,379

(22) Filed: Mar. 29, 2005

(30) Foreign Application Priority Data
Mar. 31, 2004 (JP) 2004-102832

(51) Int. Cl. G01J 1/42

(52) U.S. Cl. 356/221

(57) ABSTRACT

The movable light environment measuring system includes a measurement apparatus which measures a light environment, and a barrow for moving measurement 4 which mounts said measurement apparatus and is driven by a single wheel that contacts to a ground, wherein said measurement apparatus includes a digital camera 5 equipped with an ultra-wide angle lens 5a that is upwardly aimed, and a light data recorder 7 which records light data that said digital camera has shot and outputted in conjunction with a position and a shooting direction of said digital camera 5, and wherein the barrow for moving measurement 4 includes a measurement position and direction calculating unit which calculates a position and a shooting direction of the digital camera 5 in picture taking by the digital camera 5 based on information for autonomous navigation from an acceleration sensor 9 and a rotation angle sensor 10 which detect an acceleration and a rotation angle of the barrow, respectively, and information on a moving distance from a wheel revolution sensor 8 to provide them to the light data recorder 7. The light environment measuring system can achieve an easy measurement of a spatial distribution of a light environment according to zenithal angles even in a forest in which a GPS is hard to be utilized.

### BACKGROUND OF THE INVENTION

1. Field of the Invention

The present invention relates to a light environment measuring system that quickly measures a light environment in a forest where a change in time and space is large.

2. Related Art

A light environment measurement in a forest is not only utilized as indices of a biomass or a foliage volume of the forest, but also important for a research on growth environments of various organisms in the forest. With a growing concern on carbon dioxide storage volume and photosynthetic ability of the forest, and an increase in importance of a diversity of species in recent years, demand for a light environment measuring system has been increased. Using measured light environment values as indices is also expected for proper management of artificial plantations.

Information on a light environment according to zenithal angles is effective as a method of simply investigating a status of a forest, but the light environment in the forest is intermingled with direct lights, scattered lights, and reflected lights with variations in time and space, so that it is necessary to perform quick and repetitive multipoint measurement in which a position and a direction of a light sensor are identified in order to grasp the information on the light environment according to the zenith angles.

However, since a GPS (Global Positioning System) has been hard to be used in the forest in general, it has been difficult to quickly measure the light environment according to the zenith angles in an inhomogeneous forest on a complex terrain with identifying a measurement position.

### SUMMARY OF THE INVENTION

An object of the present invention is to advantageously solve the problem described above. A movable light environment measuring system suitable for measurement in a forest according to the present invention includes a measurement apparatus which measures a light environment, and a barrow for moving measurement which mounts said measurement apparatus and travels with a single wheel that contacts to a travel surface, wherein the measurement apparatus includes a digital camera equipped with an ultra-wide angle lens that is upwardly aimed, and a light data recorder which records light data that said digital camera has shot and outputted in conjunction with a position and a shooting direction of said digital camera, and wherein the barrow for moving measurement includes a rotation angle sensor which detects rotation angles of said barrow for moving measurement around mutually orthogonal three axes, a wheel revolution sensor which detects a revolution of said wheel, and a measurement position and direction calculating unit which calculates a position and a shooting direction of said digital camera in picture taking by said digital camera based on information for autonomous navigation from said rotation angle sensor and information of moving distance from said wheel revolution sensor to provide them to said light data recorder.

According to the light environment measuring system suitable for measurement in the forest, the barrow for moving measurement that mounts measurement apparatus is driven by hand pushing of a measuring operator or by a source of power such as a motor mounted on the barrow, and travels on a travel surface such as trackless cant in the forest, a punishing road, a mountain trail with a single wheel which contacts to the travel surface like a ground surface, a road surface, and a floor face, the rotation angle sensor detects the rotation angle of the barrow for moving measurement around mutually orthogonal three axes that are extended along, for example the antero-posterior direction, the transversal direction and the vertical direction of the barrow for moving measurement, respectively, during the travel, the wheel revolution sensor detects the rotation of the wheel of the barrow for moving measurement, and the measuring position and direction calculating unit calculates the position and the shooting direction of the digital camera in picture taking by the digital camera mounted on the barrow as the measurement apparatus based on information for autonomous navigation from the rotation angle sensor and the information on the moving distance from the wheel rotation sensor to provide them to the light data recorder.

In the measurement with the measurement apparatus mounted on the barrow for moving measurement during its travel or at an arbitrary stop, the digital camera equipped with an ultra-wide angle lens (fish-eye lens) that is upwardly aimed shoots the light environment of an actual whole sky at the current position of the barrow for moving measurement and then outputs the image data, and the light data recorder records the image data (light data) shot and outputted by the digital camera in conjunction with the current position and the shooting direction of the digital camera (corresponding relationship between left and right, and top and bottom directions on the image and the direction of the picture taking). Thus, the perfect or the actual whole sky light data which has been recorded like this is converted into a relative light intensity in the forest or the like and can be used by comparing with, for example the light data measured by the light sensor at the same time outside the forest.

Therefore, according to the light environment measuring system suitable for measurement in the forest of the present invention, since a spatial distribution of the light environment according to the zenithal angles can easily be measured even in a forest where a GPS is hard to be utilized, and the information on the light environment is also recorded simultaneously with the information on the position and the direction, the information on the light environment can be easily analyzed to be used, and in addition to that, since an ultra-wide angle lens (fish-eye lens) is used, each of the image pictures records the light data for the whole sky, so that further information can be recorded with a small amount of data.

Incidentally, according to the movable light environment measuring system of the present invention, the measuring point and direction calculating unit may includes a moving path calculating unit which continuously calculates the position of the barrow for moving measurement, and calculates the moving path of the barrow for moving measurement based on the transition of the position, and a moving path displaying unit which displays the calculated moving path on the screen, and thereby, a measuring operator in moving measurement, a researcher who analyzes measured data in afterward, or the like can identify on the screen the moving path of the barrow in the moving measurement, so that the measuring operator in the moving measurement can always identify the current position to freely perform a multi-point measurement, a line measurement, a plane measurement, or the like, to prevent the risk of distress in the forest, and the researcher who analyzes the measured data will be able to perform detailed analysis of the data with reference to another data such as such data as land features in combination.

According to the movable light environment measuring system of the present invention, the barrow for moving measurement may include an acceleration sensor which detects an acceleration of the barrow for moving measurement in the directions of mutually orthogonal three axes, and the measuring point and direction calculating unit may use the information for autonomous navigation from the acceleration sensor in order to calculate the position and the shooting direction of the digital camera, and thereby, the acceleration sensor detects the acceleration of the barrow for moving measurement in the directions of mutually orthogonal three axes that are extended along, for example the longitudinal direction, the transversal direction and the up-and-down direction of the barrow for moving measurement, respectively, and the measuring point and direction calculating unit also uses the acceleration in order to calculate the position and shooting direction of the digital camera, so that even when the acceleration is occurred caused by a shock and the like on the barrow for moving measurement, errors in the calculation of the position and the shooting direction of the digital camera can be reduced.

### BRIEF DESCRIPTION OF THE DARWINGS

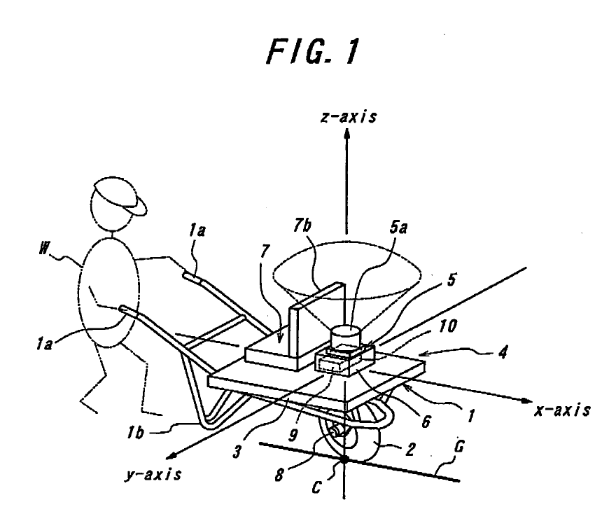

FIG. 1 is a perspective view schematically showing an external view of a movable light environment measuring system suitable for measurement in a forest as one embodiment of a light environment measuring system suitable for measurement in the forest of the present invention.

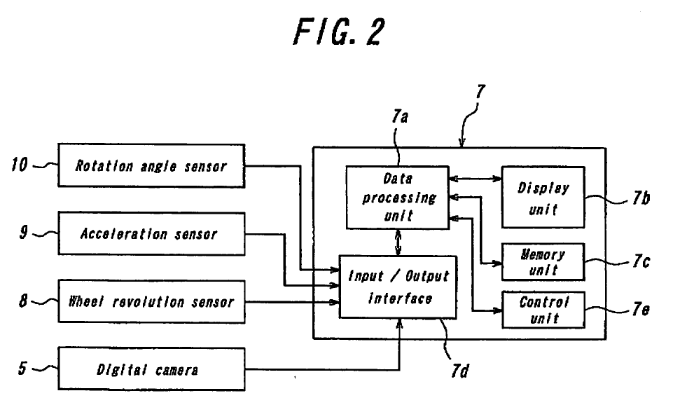

FIG. 2 is a block diagram showing a configuration of apparatuses mounted in the movable light environment measuring system suitable for measurement in the forest of the embodiment.

### BEST MODE FOR CARRYING OUT THE INVENTION

The embodiments of the present invention will be described in details in the following referring to the drawings. Herein, FIG. 1 is a perspective view schematically showing an external view of a movable light environment measuring system suitable for measurement in a forest as one embodiment of a light environment measuring system suitable for measurement in the forest of the present invention, and FIG. 2 is a block diagram showing a configuration of apparatuses mounted in the movable light environment measuring system suitable for measurement in the forest of the embodiment.

As shown in FIG. 1, the movable light environment measuring system suitable for measurement in the forest of this embodiment includes a barrow for moving measurement 4 having a frame 1 with a handle 1a for hand pushing and two feet 1b (only one of them is shown in the figure) for stopping, a single wheel 2 of which pivot is supported under the frame 1, and a top plate 3 formed on the frame 1, wherein the barrow for moving measurement 4 grounds on the ground surface G as a travel surface by the wheel 2 at the grounding point C and it travels on one wheel by hand pushing of a measuring operator W, a digital camera 5 and an angle and acceleration sensor 6 which are mounted on the top plate 3 as a measurement apparatus, respectively, a conventional note-type personal computer 7 as a light data recorder and as a measuring point and direction calculating unit and a portable power unit which is not illustrated in the figure, and a wheel revolution sensor 8 which is mounted under the frame 1 and detects revolution of the wheel 2, wherein the angle and acceleration sensor 6 contains inside an acceleration sensor 9 that detects the acceleration of the barrow for moving measurement 4 in directions of the mutually orthogonal three axes of x, y, and z, and a rotation angle sensor 10 which detects rotation angles of the barrow for moving measurement 4 around the mutually orthogonal three axes of x, y and z.

Herein, the barrow for moving measurement 4 is composed by removing original two wheels of a commercial two-wheel barrow.

(the CC3-2FA two-wheel barrow by Showa Bridge Sales Co. Ltd., for example) which are located in line on the axis that are extended along the horizontal direction, by attaching only one wheel 2 while enabling free rotation at the middle position of the former two wheels, instead, by removing the original body made of synthetic resin so that apparatuses can be easily mounted, and by attaching a flat top plate 3 made of veneer board so that it becomes to near-horizontal when a standing person holds the handle 1a by hands. The wheel revolution sensor 8 consists of two potentiometers (CPP-45RBN Kohms, by Nidec Copal Corporation, for example) which are positioned in series to the axle of the wheel 2, and since each potentiometer has a dead angle for which it cannot measure the angle, the two potentiometers are positioned as each of dead angles shifts 180 degrees each other so that no dead angles exist simultaneously.

The angle and acceleration sensor 6 includes a commercial sensor (the three axes angle sensor GU-3024 by DATA TEC Co., Ltd., for example), and as shown in FIG. 1, the x-axis of the acceleration sensor 9 accommodated therein is attached so that the x-axis of the acceleration sensor is extended in parallel with the x-axis of the rectangular coordinates inherent to the barrow for moving measurement 4 that is extended in the back and front (antero-posterior) direction of the barrow for moving measurement 4 in parallel with the surface of the top plate 3, the y-axis of the sensor is extended in parallel with the y-axis of the rectangular coordinates inherent to the barrow for moving measurement 4 that is extended in the transversal direction of the barrow for moving measurement 4 in parallel with the surface of the top plate 3, and the z-axis of the sensor is extended in parallel with the z-axis of the rectangular coordinates inherent to the barrow for moving measurement 4 that is extended in the vertical direction of the barrow for moving measurement 4 perpendicular to the surface of the top plate 3. Also, the rotation angle sensor 10 comprising a gyroscope accommodated therein is attached so that the x-axis of the sensor is extended is the back and front direction in accordance with the x-axis of the rectangular coordinates inherent to the barrow for moving measurement 4, the y-axis of the sensor is extended in the transversal direction of the barrow for moving measurement 4 in accordance with the y-axis of the rectangular coordinates inherent to the barrow for moving measurement 4, and the z-axis of the sensor is perpendicular to the axle of the barrow for moving measurement 4 at the center portion of the wheel 2 and is extended in the vertical direction of the barrow for moving measurement 4 in accordance with the z-axis of the rectangular coordinates inherent to the barrow for moving measurement 4. The portable power unit not shown in the figure includes an inverter with a built-in battery (the portable power supply Z-130 by Swallow Electric Co., Ltd., for example), and it provides the angle and acceleration sensor 6 and the personal computer 7 with AC100 V as a power supply.

Also in the embodiment, three dimensional direction acceleration data and three dimensional direction angle data detected respectively by the acceleration sensor 9 and the rotation angle sensor 10 within the angle and acceleration sensor 6 are inputted into the personal computer 7 via an RS232C cable. Power supply terminal pairs (the resistance value between the two terminals is fixed) of the two potentiometers which compose the wheel revolution sensor 8 arc mutually connected in parallel, a fixed resistor of 20 Kohms is connected in series to the parallel circuit, a voltage of about 6 V obtained by series connection of four U1 dry batteries is applied to the whole circuit, and three kinds of voltages in total, the voltage between both ends of the parallel circuit of the two potentiometers (V0) and the voltages at the output terminal (an intermediate tap with a variable resistance value) of each potentiometer (V1, V2) are inputted into the personal computer 7 as independent inputs, respectively, via an A/D) conversion card (REX-5054U by RATOC Systems, International, Inc., for example) inserted in a card slot of the personal computer 7.

The digital camera 5 is a commercial single-lens reflex type camera equipped with an ultra-wide angle lens (fish-eye lens) 5a for measurement of light environment for the whole sky in the forest, and in the embodiment, as shown in FIG. 1, the digital camera is fixed on the top plate 3 via the housing of the angle and acceleration sensor 6 so that the ultra-wide angle lens 5a upwardly directs in accordance with the z-axis of the rectangular coordinates inherent to the barrow for moving measurement 4, and portions of the digital camera which vertically positions when the camera takes horizontal posture are located on the x-axis of the rectangular coordinates inherent to the barrow for moving measurement 4, and digital image data as light data which the digital camera 5 shoots inside a forest and outputs is inputted into the personal computer 7 via an USB (Universal Serial Bus) terminal, for example.

The personal computer 7 includes, as shown in FIG. 2, a data-processing unit 7a with CPU (central processing unit), a display unit 7b with a liquid crystal display, a memory unit 7c with a memory or a hard disk drive unit and the like, an input/output interface 7d containing a card inserted in the card slot, and a control unit 7e with a key board and the like, thereby, based on two kinds of programs of a moving measurement program which makes the personal computer 7 work as a measuring point and direction calculating unit and a light data recording and analyzing program which makes the personal computer 7 work as a light data recorder and a light data analyzer which are memorized in advance in the memory unit 7c, the personal computer 7 displays data from each sensors 8 to 10 in conjunction with light data from the digital camera 5 on a screen by the display unit 7b and records them into the memory unit 7c, as will be described later, and also calculates the light environment in the forest from such data and outputs the result. As for output voltages V1 and V2 of the two potentiometers that include the wheel revolution sensor 8, after selecting the output not corresponding to the dead angle by comparing values of V1/V0 and V2/V0, these values are converted to the rotation angle of the wheel 2.

When performing moving measurement of light environment in the forest by using the portable light environment measuring system suitable for measurement in the forest of the embodiment, the personal computer 7 is turned on first to activate the moving measurement program, and at the same time, the angle and acceleration sensor 6 is turned on to activate the acceleration sensor 9 and the rotation angle sensor 10, and positions of x, y, and z axes at the sensor activation are used as the basic coordinate axes by the personal computer 7 that operates based on the moving measurement program.

Subsequently, when a measuring operator makes the barrow for moving measurement 4 travel by hand pushing, the personal computer 7 momentarily calculates a moving distance of the barrow for moving measurement 4 from the rotation angle of the wheel 2 and the outer diameter of the wheel 2 which are converted from output data of potentiometers which include the wheel revolution sensor 8, calculates the current position of the digital camera 5 by decomposing the moving distance into each component of x, y, and z axes of the basic coordinate axes by using three dimensional direction angle data of the posture of the barrow for moving measurement 4 obtained from output data of the rotation angle sensor 10, calculates the current zenithal angle and the current azimuthal angle in the shooting direction of the digital camera 5 by using three dimensional direction angle data of the posture of the barrow for moving measurement 4 obtained from output data of the rotation angle sensor 10, and records these data into a hard disk by using the hard disk drive unit of the memory unit 7c.

During the measuring operator is moving the barrow for moving measurement 4 or when the person stops the barrow arbitrarily, the personal computer 7 processes image data which the digital camera 5 shoots and outputs by using the ultra-wide angle lens (fish-eye lens) 5a as light data for the whole sky or for actually the whole sky to form measured data with a predetermined data format, and records these data into the hard disk by using the hard disk drive unit of the memory unit 7c, relating these data to the current position and the shooting direction of the digital camera 5 (corresponding relationship between left, right, top and bottom directions on the image and directions of picture taking).

Since it cannot be expected to make the barrow for moving measurement 4 travel by hand pushing maintaining the top plate 3 accurately in parallel to the gradient of the ground surface G in the back and front direction of the barrow for moving measurement 4, the gradient of the top plate 3 toward the ground surface G at the level ground when the handle 1a of the barrow for moving measurement 4 is held by hands of each measuring operator is checked out and inputted into the personal computer 7 for each measuring operator in advance, and the personal computer 7 compensates for the rotation angle acquired from output data of rotation angle sensor 10 by the gradient value.

When the revolution state of wheel 2 based on output data of the wheel revolution sensor 8 and the acceleration generation state based on output data of the acceleration sensor 9 do not correspond (when acceleration to the back and front direction is detected although the wheel 2 is not revolving, for example), since it can be presumed that acceleration by a shock and the like has been applied to the barrow for moving measurement 4 to generate acceleration causing the wheel 2 not to rotate according to an actual moving distance, the personal computer 7 performs second order integration of the acceleration that the acceleration sensor 9 detected so as to calculate the moving distance in the acceleration direction, and then compensates for the moving distance calculated from the rotation angle of the wheel 2, by using the moving distance calculated from the acceleration value.

The personal computer 7 further calculates the moving trajectory of the barrow for moving measurement 4 from the transition of the current position of the measurement apparatus 5, as well as displays the calculated moving trajectory of the barrow for moving measurement 4 on a map or a plan view on the liquid crystal display screen of the display unit 7b, wherein measurement result obtained by the measurement apparatus 5 is also simultaneously displayed on the liquid crystal display screen of the display section 7b, or displayed on a switched new page on the screen.

On the other hand, in an open space outside the forest, another digital camera having the same specification as those of the digital camera 5 is located as its shooting direction is set toward upward vertically, and light data of outside the forest shot and outputted by the digital camera for every predetermined time are recorded by a data logger (recorder) (the data logger LI-1400, made by LI-COR, Inc., U.S., and imported by MEIWA SHOJI CO. LTD., for example) together with time data.

The personal computer 7 performs the light data recording and analyzing program after moving measurement by the movable light environment measuring system is finished, reads the position of digital camera 5 performing measurement and image data (light data) for the whole sky which digital camera 5 has shot from the hard disk by using the hard disk drive unit of the memory unit 7c, inputs light data of outside the forest from the data logger as values of measured light data of outside the forest together with time data, divides luminance values of the whole sky image data shot by the digital camera 5 by values of measured light data of outside the forest to transform into relative luminance values, and outputs these values, as space and time distribution data of the light environment characteristics in the forest, on the liquid crystal display screen of the display section 7b, or on the hard disk of the hard disk drive unit of the memory unit 7c as a form of records and the like.

Therefore, according to the movable light environment measuring system of the embodiment, since a spatial distribution of the light environment according to the zenithal angles can easily be measured even in a forest where a GPS is hard to be utilized, and the information on the light environment is also recorded simultaneously with the information on the position and the direction, the information on the light environment can be easily analyzed to be used, and in addition to that, since an ultra-wide angle lens 5a (fish-eye lens) is used, each of the image pictures records the light data for the whole sky, so that further information can be recorded with a small amount of data.

According to the movable light environment measuring system of the embodiment, since the personal computer 7 as the measuring point and direction calculating unit calculates the position of the barrow for moving measurement 4 continuously, works as the moving path calculating unit that calculates the moving path of the barrow for moving measurement 4 based on the transition of its position, and works also as the moving path displaying unit that displays the calculated moving path on the screen, so that such persons as a measuring operator who performs moving measurement or a researcher who afterwards analyzes measured data can identify on the screen the moving path of the barrow performing moving measurement 4, the measuring operator in the moving measurement can always identify the current position to freely perform a multi-point measurement, a line measurement, a plane measurement, or the like, to prevent the risk of distress in the forest, and the researcher who analyzes the measured data will be able to perform detailed analysis of the data with reference to another data such as such data as land features in combination.

According to the movable light environment measuring system of the embodiment, since the acceleration sensor 9 detects the acceleration of the barrow for moving measurement 4 in directions of the mutually orthogonal three axes which are extended in the directions of longitudinal direction, the transversal direction, and up-and-down direction of the barrow for moving measurement 4, respectively, and since the personal computer 7 as the measuring point and Orientation calculating unit also uses the acceleration in order to calculate the position and the shooting direction of the digital camera 5, even when an acceleration is occurred caused by a shock and the like on the barrow for moving measurement 4, errors in the calculation of the position and shooting direction of the digital camera 5 can be reduced.

Although the present invention is described based on the illustrated embodiment, the present invention is not limited to the embodiment described heretofore. That is, the digital camera mounted with the ultra-wide angle lens is not limited to the single-lens reflex type camera. The camera may be, for example, a so-called video camera for shooting moving images instead of the digital camera for shooting still images, and in addition to the digital camera mounted with the ultra-wide angle lens, other light sensors, such as a photon sensor, may be further added as another measurement apparatus.

Furthermore, according to the present invention, The barrow for moving measurement may mount a source of power such as a motor, for assisting hand pushing by a measuring operator, or for self-propelling with the measuring operator only holding its handle. According to the present invention, the barrow for moving measurement is not limited to the hand pushing type, and a horse or a donkey and the like may make the barrow travel by wearing a harness to hold the handle and the like of the barrow.

### INDUSTRIAL APPLICABILITY

Thus, according to the light environment measuring system suitable for measurement in a forest of the present invention, since a spatial distribution of the light environment according to the zenithal angles can easily be measured even in a forest where a GPS is hard to be utilized, and the information on the light environment is also recorded simultaneously with the information on the position and the direction, the information on the light environment can be easily analyzed to be used, and in addition to that, since an ultra-wide angle lens (fish-eye lens) is used, each of the image pictures records the light data for the whole sky, so that further information can be recorded with a small amount of data.

1. A movable light environment measuring system, comprising:
a measurement apparatus which measures a light environment; and
a barrow for moving measurement which mount said measurement apparatus and travels with a single wheel that contacts to a travel surface,
wherein said measurement apparatus comprises
a digital camera equipped with an ultra-wide angle lens that is upwardly aimed, and
a light data recorder which records light data that said digital camera has shot and outputted in conjunction with a position and a shooting direction of said digital camera, and
wherein said barrow for moving measurement comprises
a rotation angle senor which detects rotation angles of said barrow for moving measurement around mutually orthogonal three axes,
a wheel revolution sensor which detects a revolution of said wheel, and
a measurement position and direction calculating unit which calculates a position and a shooting direction of said digital camera in picture taking by said digital camera based on information for autonomous navigation from said rotation angel sensor and information on a moving distance from said wheel revolution sensor to provide them to said light data recorder.

2. The movable light environment measuring system according to claim 1, wherein said measurement position and direction calculating unit comprises
a moving path calculating unit which continuously calculates a position of said barrow for moving measurement, and calculates a moving path of said barrow for moving measurement based on a transition of the position, and
a moving path displaying unit which displays said calculated moving path on a screen.

3. The movable light environment measuring system according to claim 1, wherein
said barrow for moving measurement comprises an acceleration sensor that detects an acceleration of said barrow for moving measurement in directions of the mutually orthogonal three axes, and
said measurement position and direction calculating unit also uses the information for autonomous navigation from said acceleration sensor in order to calculate the position and the shooting direction of said digital camera.

4. The movable light environment measuring system according to claim 2, wherein
said barrow for moving measurement comprises an acceleration sensor that detects an acceleration of said barrow for moving measurement in directions of the mutually orthogonal three axes, and
said measurement position and direction calculating unit also uses the information for autonomous navigation from said acceleration sensor in order to calculate the position and the shooting direction of said digital camera.
